(19) United States
(12) Patent Application Publication
(10) Pub. No.: US 2025/0110278 A1
(43) Pub. Date: Apr. 3, 2025

(54) DIRECTIONAL COUPLER AND METHOD OF MANUFACTURING THE SAME

(71) Applicant: Mitsubishi Electric Corporation, Tokyo (JP)

(72) Inventors: Keita MOCHIZUKI, Tokyo (JP); Kazumasa KISHIMOTO, Tokyo (JP)

(73) Assignee: Mitsubishi Electric Corporation, Tokyo (JP)

(21) Appl. No.: 18/729,007

(22) PCT Filed: Jun. 16, 2022
(86) PCT No.: PCT/JP2022/024158

§ 371 Date: Jul. 15, 2024

(51) Int. Cl. G02B 6/28

(52) U.S. Cl. CPC G02B 6/2821

(57) ABSTRACT

An interval between the first and second optical waveguides (2c,3c) of the optical power transition unit is equal to or less than a wavelength of the light. Each of the first and second optical waveguides (2c,3c) is a high-mesa structure which includes a lower cladding layer (5), a core layer (6a,6b), and an upper cladding layer (7a,7b) which are sequentially stacked on the semiconductor substrate (1). The first optical waveguide and the second optical waveguide have different widths. A gap core layer (6c) is formed on the lower cladding layer between the core layers of the first and second optical waveguides of the optical power transition unit. An equivalent refractive index of the gap core layer when leakage of the light in a height direction is taken into consideration is lower than an equivalent refractive index of the core layers of the first and second optical waveguides.

### FIELD

The present disclosure relates to a directional coupler constituted of an InP-based high-mesa optical waveguide and to a method of manufacturing the same.

### BACKGROUND ART

Various materials such as silicon (Si), indium phosphide (InP), gallium arsenide (GaAs), gallium nitride (GaN), and lithium niobate (LiNbO₃) or compound semiconductors based on these substances are used as materials of optical semiconductor devices. An optical waveguide is widely used as a basic component in such optical semiconductor devices. An optical waveguide traps light into a local region by making a refractive index higher than a periphery and causes light to propagate in a desired direction by forming the region into a linear shape.

In addition, a directional coupler is also widely used as a basic component of optical semiconductor devices for realizing various functions. A directional coupler optically couples light propagation modes of two independent optical waveguides by bringing the optical waveguides close to each other to a distance equal to or shorter than a wavelength of propagated light. Accordingly, a transition of any power of the propagated light can be performed.

However, in a general directional coupler, there is a problem in that causing optical power that propagates through one optical waveguide to sufficiently transition to the other optical waveguide requires a long distance of around several ten times the wavelength of propagated light and increases device size.

Furthermore, with a 3 dB coupler and a 3 dB splitter which are often used in directional couplers and which branch 50% of optical power to another branch, there is also a problem in that an admissible error range of a device length in which a desired transition ratio is obtained is around approximately 1 micrometer which is extremely narrow. A device length of the admissible error range being small relative to an overall device length means that the directional coupler is a device which is proportionally vulnerable to manufacturing error.

As a technique for solving these problems, a technique is disclosed in which a so-called Sub-wavelength Grating (SWG) structure is introduced into a directional coupler constituted of a Si-based thin wire waveguide to reduce a transition distance of optical power from one optical waveguide to another optical waveguide (for example, refer to NPL 1). An SWG structure is a periodic structure of which periodicity is equal to or smaller than propagated light and which is provided in a perpendicular direction with respect to two optical waveguides that are close to each other at a distance that is more or less equivalent to a wavelength while setting waveguide widths of the two optical waveguides to different values. In this method, a transition distance of optical power is reduced by introducing asymmetric waveguide widths and a decline in a transition ratio of optical power that becomes a problem when reducing the transition distance is compensated for by the SWG structure. Accordingly, a 3 dB coupler with a short device length despite being a directional coupler is successfully realized.

### CITATION LIST

### Non Patent Literature

[NPL 1] C. Ye et al., “Ultra-Compact Broadband 2×23 dB Power Splitter Using a Subwavelength-Grating-Assisted Asymmetric Directional Coupler,” Journal of Lightwave Technology, vol. 38, no. 8 (2020)

### SUMMARY

### Technical Problem

With a Si thin wire waveguide, optical waveguide widths are 0.5 micrometers or less and a structure in which two optical waveguides are brought close to each other to 0.2 micrometers or less can be readily formed. Applying related art to optical waveguides other than such Si thin wire waveguides is difficult. In particular, a deep engraved portion is necessary since trapping in a height direction of an optical waveguide is insufficient. On the other hand, with an InP-based high-mesa optical waveguide, optical waveguide widths of 0.5 micrometers or more and a distance between two optical waveguides are necessary. Therefore, applying related art to InP-based high-mesa optical waveguides is difficult.

The present disclosure has been made in order to solve such problems and an object thereof is to obtain a directional coupler which can also be applied to an InP-based high-mesa optical waveguide, which has a small device size, and which is strong against manufacturing error and to obtain a method of manufacturing the directional coupler.

### Solution to Problem

A directional coupler according to the present disclosure includes: a semiconductor substrate; first and second optical waveguides formed side by side on the semiconductor substrate and having a high-mesa structure; and a peripheral cladding formed in a periphery of the first and second optical waveguides, wherein the first and second optical waveguides include an optical power transition unit branching light propagating along one of the first and second optical waveguides at a desired power ratio to the first and second optical waveguides, first curved waveguides connected to an input side of the optical power transition unit and decreasing an interval between the first and second optical waveguides the closer to the optical power transition unit, and second curved waveguides connected to an output side of the optical power transition unit and increasing an interval between the first and second optical waveguides the farther from the optical power transition unit, an interval between the first and second optical waveguides of the optical power transition unit is equal to or less than a wavelength of the light, each of the first and second optical waveguides is a high-mesa structure which includes a lower cladding layer, a core layer, and an upper cladding layer which are sequentially stacked on the semiconductor substrate, the first and second optical waveguides have different widths, a gap core layer is formed on the lower cladding layer between the core layers of the first and second optical waveguides of the optical power transition unit, and an equivalent refractive index of the gap core layer when leakage of the light in a height direction is taken into consideration is lower than an equivalent refractive index of the core layers of the first and second optical waveguides.

### Advantageous Effects of Invention

In the present disclosure, the gap core layer is designed so that the equivalent refractive index of the gap core layer when leakage of light in a height direction is taken into consideration becomes lower than the equivalent refractive index of the core layer of the optical waveguide. Accordingly, a directional coupler which can also be applied to an InP-based high-mesa optical waveguide, which has a small device size, and which is strong against manufacturing error can be obtained.

### BRIEF DESCRIPTION OF THE DRAWINGS

FIG. 1 is a top view showing a directional coupler according to a first embodiment.

FIG. 2 is a perspective view showing the optical power transition unit of the directional coupler according to the first embodiment.

FIG. 3 is a diagram showing a result of a calculation of branching ratios of the directional coupler with respect to the structure according to the first embodiment, a conventional high-mesa waveguide structure, and a conventional embedded waveguide structure.

FIG. 4 is a sectional view showing the structure according to the first embodiment used in the calculation shown in FIG. 3.

FIG. 5 is a sectional view showing the conventional high-mesa waveguide structure used in the calculation shown in FIG. 3.

FIG. 6 is a sectional view showing the conventional embedded waveguide structure used in the calculation shown in FIG. 3.

FIG. 7 is a diagram showing, by an overlap integral, a result of a calculation of a ratio of optical power included in each of the two optical waveguides with respect to an optical power distribution at each z position in FIG. 3.

FIG. 8 is a diagram showing a result of a calculation of a branching ratio of optical power with respect to a position in the length direction of the directional coupler.

FIG. 9 is a diagram showing a result of a calculation of a branching ratio of optical power with respect to a position in the length direction of the directional coupler.

FIG. 10 is a diagram showing a result of a calculation of a branching ratio of optical power with respect to a position in the length direction of the directional coupler.

FIG. 11 is a diagram showing a result of a calculation of a branching ratio of optical power with respect to a position in the length direction of the directional coupler.

FIG. 12 is a perspective view showing a directional coupler according to a second embodiment.

FIG. 13 is a diagram showing a result of a calculation of a branching ratio of the directional coupler in the structure according to the second embodiment.

FIG. 14 is a diagram showing, by an overlap integral, a result of a calculation of a ratio of optical power included in each of the input-side first optical waveguide and the second optical waveguide with respect to an optical power distribution at each z position in FIG. 13.

FIG. 15 is a perspective view showing a directional coupler according to a third embodiment.

FIG. 16 is a plan view showing a mask used when forming a waveguide.

FIG. 17 is a perspective view showing a directional coupler according to a fourth embodiment.

FIG. 18 is a perspective view showing a directional coupler according to a fifth embodiment.

FIG. 19 is a perspective view showing a directional coupler according to a sixth embodiment.

### DESCRIPTION OF EMBODIMENTS

A directional coupler and a method of manufacturing the same according to the embodiments of the present disclosure will be described with reference to the drawings. The same components will be denoted by the same symbols, and the repeated description thereof may be omitted.

### First Embodiment

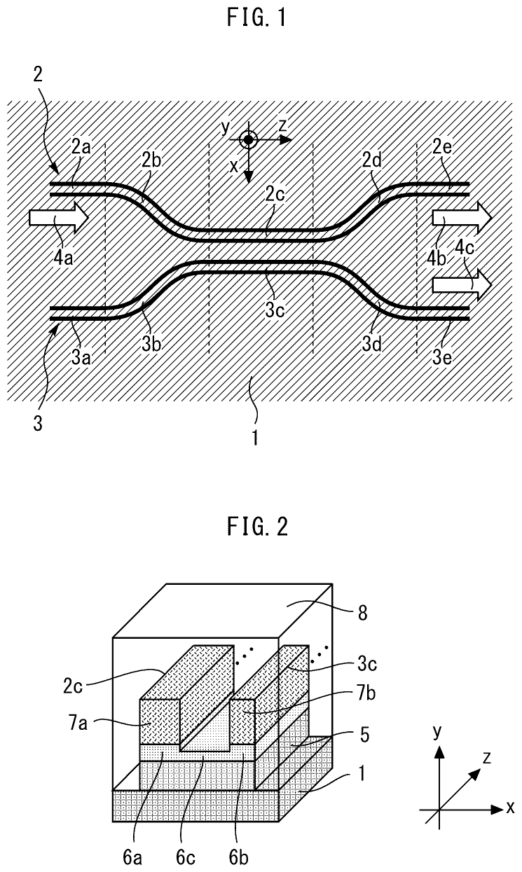

FIG. 1 is a top view showing a directional coupler according to a first embodiment. Two optical waveguides 2 and 3 are formed side by side on a semiconductor substrate 1. The optical waveguides 2 and 3 are a region with a higher refractive index than a periphery thereof. Light is locally trapped in this region. Light is allowed to propagate only in a specific direction of the optical waveguides 2 and 3. The optical waveguide 2 includes optical waveguides 2a to 2e. The optical waveguide 3 includes optical waveguides 3a to 3e. Note that in FIG. 1, light 4a inputted to the directional coupler and beams of output light 4b and 4c having been branched by the directional coupler are schematically depicted by arrows.

Input-side optical waveguides 2a and 3a of the directional coupler are arranged side by side. An interval between the optical waveguides 2a and 3a is a sufficient distance that is equal to or more than several times a wavelength of propagated light. One ends of optical waveguides 2b and 3b are respectively connected to the optical waveguides 2a and 3a. Shapes of the optical waveguides 2b and 3b are a combination of arcs, a combination of a sine wave and a cosine wave, a cycloid curve, a clothoid curve, or the like. The optical waveguides 2b and 3b connected to an input side of an optical power transition unit are curved waveguides which decreases an interval between the optical waveguides 2 and 3 the closer to the optical power transition unit and which cause the interval between the optical waveguides 2 and 3 to be brought close to each other without light loss from several times a magnitude of the wavelength of propagated light or more to around the magnitude of the wavelength. Lengths of the optical waveguides 2b and 3b are around 10 times the wavelength of propagated light or more.

One ends of optical waveguides 2c and 3c of the optical power transition unit are respectively connected to other ends of the optical waveguides 2b and 3b. The optical waveguides 2c and 3c are arranged parallel to and close to each other. An interval between the optical waveguides 2c and 3c is around the wavelength of propagated light or less. The optical power transition unit branches light propagating along one of the optical waveguides 2c and 3c at a desired power ratio to the optical waveguides 2c and 3c.

One ends of optical waveguides 2d and 3d are respectively connected to other ends of the optical waveguides 2c and 3c. Shapes of the optical waveguides 2d and 3d are a combination of arcs, a combination of a sine wave and a cosine wave, a cycloid curve, or the like. The optical waveguides 2d and 3d connected to an output side of the optical power transition unit are curved waveguides which increase the interval between the optical waveguides 2 and 3 the farther from the optical power transition unit, the longer the interval and which cause the interval between the optical waveguides 2 and 3 to increase without light loss from around the wavelength of propagated light to several times the wavelength or more. Lengths of the optical waveguides 2d and 3d are around 10 times the wavelength of propagated light or more. Optical waveguides 2e and 3e on an output side of the directional coupler are respectively connected to other ends of the optical waveguides 2d and 3d.

FIG. 2 is a perspective view showing the optical power transition unit of the directional coupler according to the first embodiment. Note that an x axis and a y axis are drawn in the diagram so that a correspondence of directions between FIGS. 1 and 2 can be comprehended. The optical waveguide 2c is a high-mesa structure which includes a lower cladding layer 5, a core layer 6a, and an upper cladding layer 7a which are sequentially stacked on the semiconductor substrate 1. The optical waveguide 3c is a high-mesa structure which includes the lower cladding layer 5, a core layer 6b, and an upper cladding layer 7b which are sequentially stacked on the semiconductor substrate 1.

The core layers 6a and 6b are regions which are made of a material with a higher refractive index than the lower cladding layer 5 and the upper cladding layers 7a and 7b and which trap light. A gap core layer 6c is formed on top of the lower cladding layer 5 between the core layers 6a and 6b of the optical waveguides 2c and 3c of the optical power transition unit. The gap core layer 6c is made of a same material as the core layers 6a and 6b and a height of an upper surface is engraved deeper than the core layers 6a and 6b.

A peripheral cladding 8 is formed in a periphery of the optical waveguides 2c and 3c. The peripheral cladding 8 is made of a material such as SiO₂ or SiN with a lower refractive index than the refractive indexes of the lower cladding layer 5, the core layers 6a and 6b, the upper cladding layers 7a and 7b, and the gap core layer 6c.

A width of the optical waveguide 2c is approximately 1.5 times a width of the optical waveguide 3c. In a similar manner, the widths of the optical waveguides 2a to 2e are approximately 1.5 times the widths of the optical waveguides 3a to 3e. Therefore, the directional coupler according to the present embodiment is an asymmetric directional coupler in which the optical waveguide 2 and the optical waveguide 3 have different widths. Note that widths of the optical waveguides 2 and 3 are equal to or shorter than a net wavelength of propagated light and an overall height is equal to or longer than the net wavelength. Since the core layers 6a and 6b and the gap core layer 6c are formed on top of the shared lower cladding layer 5, a height of a lower surface of the gap core layer 6c is the same as a height of lower surfaces of the core layers 6a and 6b. In addition, the gap core layer 6c and the core layers 6a and 6b are in contact with each other.

An equivalent refractive index of the gap core layer 6c is calculated in consideration of leakage of light from the gap core layer 6c to the peripheral cladding 8 and the lower cladding layer 5. An equivalent refractive index of the core layers 6a and 6b is calculated in consideration of leakage of light from the core layers 6a and 6b to the upper cladding layers 7a and 7b and the lower cladding layer 5. Generally, the thinner the thickness of a core layer, the more light leaks to upper and lower cladding layers and an equivalent refractive index declines. In consideration thereof, in the present embodiment, the gap core layer 6c is engraved deeper than the core layers 6a and 6b of the optical waveguides 2c and 3c so that the equivalent refractive index of the gap core layer 6c when leakage of light in a height direction is taken into consideration becomes lower than the equivalent refractive index of the core layers 6a and 6b of the optical waveguides 2c and 3c.

Specifically, an engraved amount of the gap core layer 6c is adjusted so that an equivalent refractive index n_{eff} of the gap core layer 6c when leakage of light in the height direction is taken into consideration satisfies equation (1) below with an error of 10% or less.

$${n}_{eff} = ( {n}_{core} - {n}_{clad} ) \times 0.09 \times ln ( {k}_{0} {w}_{gap} / 4.2 ) + 1. + {n}_{clad} \qquad ( 1 )$$

In equation (1), n_{core} denotes a refractive index of the core layers 6a and 6b and the gap core layer 6c. In addition, n_{clad} denotes a refractive index of the peripheral cladding 8. Furthermore, k₀ denotes the number of waves of light propagating through a vacuum. In addition, w_{gap} denotes a proximity distance of the optical waveguides 2c and 3c of the optical power transition unit or, in other words, a width of the gap core layer 6c.

A high-mesa waveguide more strongly traps light into an optical waveguide as compared to other optical waveguides such as an embedded waveguide or a thin wire waveguide. In addition, since deep etching is required to generate a gap portion between the two optical waveguides of the optical power transition unit, the width w_{gap} of the gap portion needs to be a certain value or more. With such a structure, light propagation modes in the two optical waveguides are not sufficiently optically coupled and sufficient transition of optical power hardly occurs. In consideration thereof, in the present embodiment, by causing a part of the gap core layer 6c to remain in the gap portion, the respective light propagation modes are intentionally extended in a direction of the gap portion to strengthen optical coupling. Furthermore, since a difference in propagation constants of the respective light propagation modes of the optical waveguides 2c and 3c of the optical power transition unit increases by adopting asymmetric waveguide widths in which the widths of the optical waveguides 2c and 3c differ from each other, a transition distance of optical power from one optical waveguide to the other optical waveguide can be reduced. As a result, a directional coupler which achieves both a short transition distance of optical power and a transition ratio of optical power of around 50% at a maximum can be realized.

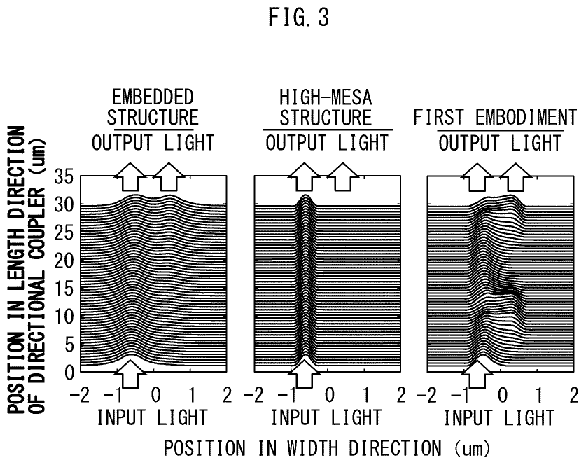

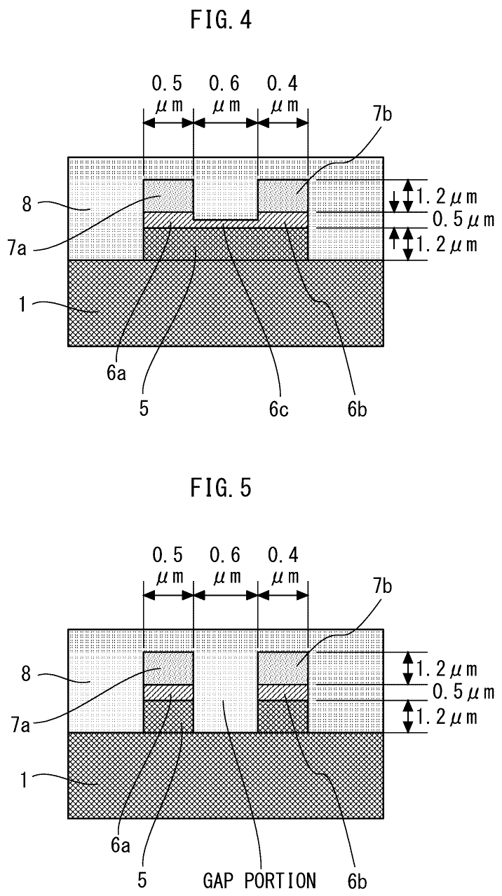

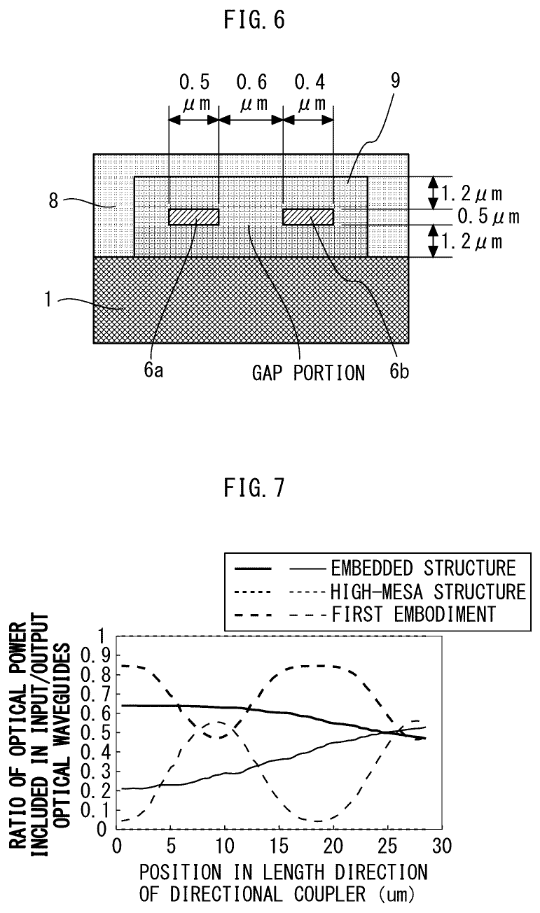

FIG. 3 is a diagram showing a result of a calculation of branching ratios of the directional coupler with respect to the structure according to the first embodiment, a conventional high-mesa waveguide structure, and a conventional embedded waveguide structure. FIG. 4 is a sectional view showing the structure according to the first embodiment used in the calculation shown in FIG. 3. FIG. 5 is a sectional view showing the conventional high-mesa waveguide structure used in the calculation shown in FIG. 3. In the conventional high-mesa waveguide structure, the gap portion is completely engraved. FIG. 6 is a sectional view showing the conventional embedded waveguide structure used in the calculation shown in FIG. 3. In the conventional embedded waveguide structure, after completely engraving the gap portion, a periphery thereof is completely embedded with an InP layer 9 of which a refractive index is 3.17.

Any of the structures is an asymmetric directional coupler in which the light input-side optical waveguide 2c and the light output-side optical waveguide 3c are brought close to each other while sandwiching a gap portion with a width of 0.6 micrometers. The optical waveguides 2c and 3c are surrounded by the peripheral cladding 8 made of SiO₂ with a refractive index of 1.45. The width of the optical waveguide 2c is 0.6 micrometers. The width of the optical waveguide 3c is 0.4 micrometers. The optical waveguide 2c includes the upper cladding layer 7a made of InP with a refractive index of 3.17 and of which a thickness is 1.2 micrometers, the core layer 6a made of an AlGalnAs multiple quantum well with an average refractive index of 3.32 and of which a thickness is 0.5 micrometers, and the lower cladding layer 5 made of InP with a refractive index of 3.17 and of which a thickness is 1.2 micrometers. The optical waveguide 3c includes the upper cladding layer 7b made of InP with a refractive index of 3.17 and of which a thickness is 1.2 micrometers, the core layer 6b made of an AlGaAsAs multiple quantum well with an average refractive index of 3.32 and of which a thickness is 0.5 micrometers, and the lower cladding layer 5 made of InP with a refractive index of 3.17 and of which a thickness is 1.2 micrometers. In the structure according to the first embodiment, the equivalent refractive index of the gap core layer 6c is 3.129.

An axis of abscissa in FIG. 3 represents a position in a width direction of the directional coupler and corresponds to the x axis in FIGS. 1 and 2. An axis of ordinate in FIG. 3 represents a position in a length direction of the directional coupler and corresponds to the z axis in FIGS. 1 and 2. The plurality of curves in FIG. 3 represent power distributions of light taken every 0.5 micrometers in the z-direction being displayed overlapped and are illustrated so that x positions where light is localized are visually readily comprehensible. A vicinity of x=−0.6 micrometers in FIG. 3 is where the optical waveguide 2c is installed. A vicinity of x=0.4 micrometers in FIG. 3 is where the optical waveguide 3c is installed.

FIG. 7 is a diagram showing, by an overlap integral, a result of a calculation of a ratio of optical power included in each of the two optical waveguides with respect to an optical power distribution at each z position in FIG. 3. The calculation results show that, with the conventional embedded waveguide structure, a length of 25 micrometers is necessary for the light branching ratio to reach 50%. It is also shown that, with the conventional high-mesa waveguide structure, the optical coupling between the two optical waveguides is too weak and a transition of optical power hardly occurs no matter how long the directional coupler. On the other hand, with the structure according to the first embodiment, it is shown that the branching ratio of optical power is 50% when the length of the directional coupler is near approximately 8 micrometers and, compared to conventional structures, a reduction in length of the directional coupler by approximately ⅓ and a power transition ratio of 50% are realized.

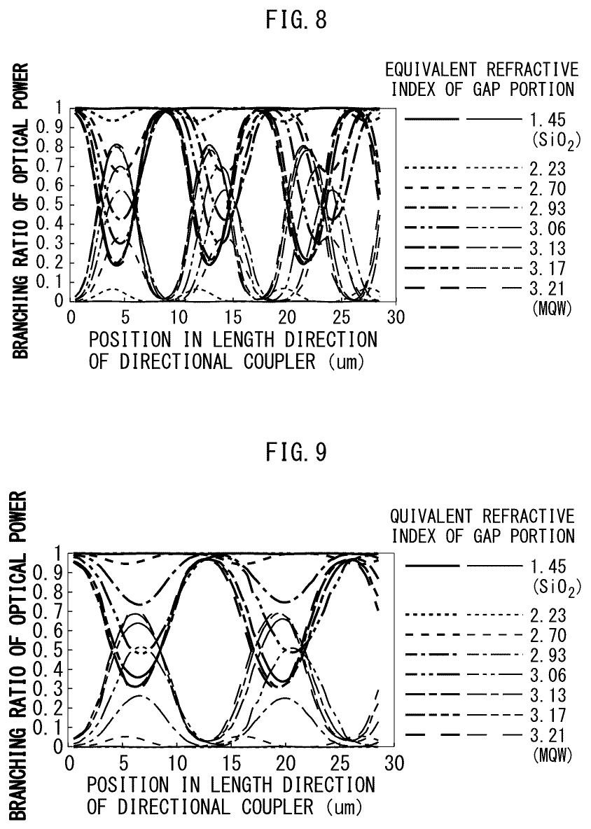

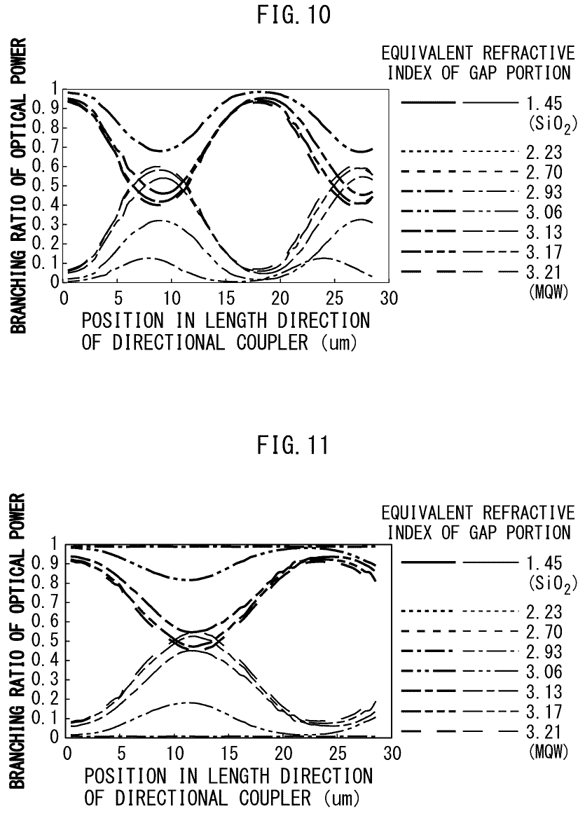

Next, an effect of equation (1) will be described. FIGS. 8 to 11 are diagrams showing results of calculations of a branching ratio of optical power with respect to positions in the length direction of the directional coupler. A branching ratio refers to a ratio of optical power included in each of the two optical waveguides. In the structure shown in FIG. 4, a height of the gap core layer is changed so as to change the equivalent refractive index of the gap portion from the refractive index 1.45 of SiO₂ of the peripheral cladding to the refractive index 3.21 of the multiple quantum well of the core layer. FIGS. 8 to 11 represent cases where the gap width w_{gap} between the two optical waveguides is respectively set to 0.2 micrometers, 0.4 micrometers, 0.6 micrometers, and 0.8 micrometers.

An equivalent refractive index condition indicated by a bold line in each diagram represents a condition that is closest to equation (1). Each diagram shows that, when the condition of equation (1) is satisfied, the optical power branching ratio at a peak position of a graph is approximately 50%. The optical power branching ratio is 50% at a peak position of the graph where a gradient of the graph is minimized or, in other words, in a region where a change in the optical power branching ratio is minimized. Therefore, a range of the z position where the optical power branching ratio is approximately 50% widens and a directional coupler that is robust with respect to manufacturing error can be realized. In this case, for example, when an error of the optical power branching ratio is set to +10%, the condition of equation (1) is to be allowed an error of approximately 10% from an optimal condition.

As described above, in the present embodiment, the gap core layer 6c is designed so that the equivalent refractive index of the gap core layer 6c when leakage of light in a height direction is taken into consideration becomes lower than the equivalent refractive index of the core layers 6a and 6b of the optical waveguides 2c and 3c. Specifically, an engraved amount of the gap core layer 6c is adjusted so that an equivalent refractive index n_{eff} of the gap core layer 6c when leakage of light in the height direction is taken into consideration satisfies equation (1) with an error of 10% or less. Accordingly, a directional coupler which can also be applied to an InP-based high-mesa optical waveguide, which has a small device size, and which is strong against manufacturing error can be obtained.

Note that a shape, a material, and a positional relationship of the directional coupler are not limited to those of the present embodiment. For example, positions of the input-side optical waveguide and the output-side optical waveguide may be interchanged. The material of the semiconductor substrate 1 may be other material such as Si, GaAs, SiO2, SiN, or LiNbO₃. The core layers need not be multiple quantum wells and need only be a material with a higher refractive index than the cladding layers and the core layers may be, for example, SiO₂ such as a SiO₂ cladding doped with Ge or the like. In this case, while a decrease in the refractive index of the device as a whole is disadvantageous in terms of increasing the device size, since light loss of propagated light decreases, a low-loss device can be realized.

### Second Embodiment

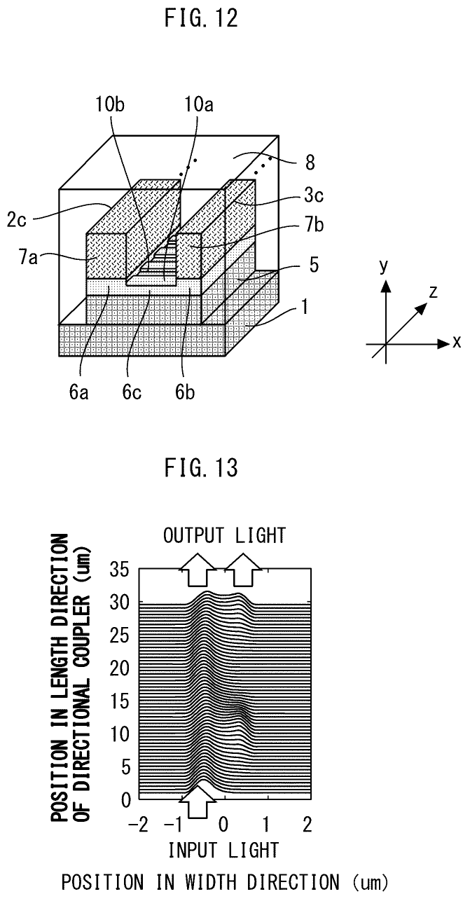

FIG. 12 is a perspective view showing a directional coupler according to a second embodiment. The gap core layer 6c is made of a same material as the core layers 6a and 6b and is an SWG (Sub-wavelength Grating) structure which is partially engraved so that a height thereof is lower than the core layers 6a and 6b and in which first and second regions 10a and 10b with different heights are periodically repeated at a pitch equal to or shorter than a length of a net wavelength of light propagating through the optical waveguides 2c and 3c.

An equivalent refractive index n_{gap1} of the first region 10a and an equivalent refractive index n_{gap2} of the second region 10b when the leakage of light in the height direction described earlier is taken into consideration satisfy equation (2) below with an error of 10% or less.

$$( {n}_{core} - {n}_{clad} ) \times 0.09 \times ln ( {k}_{0} {w}_{gap} / 4.2 ) + 1. + {n}_{clad} = \frac{1}{f / {n}_{gap 1} + ( 1 - f ) / {n}_{gap 2}} \qquad ( 2 )$$

In equation (2), n_{gap1} and n_{gap2} respectively denote equivalent refractive indexes of the first and second regions 10a and 10b and f denotes a filling factor indicating a proportion of a length in a light propagation direction of the first region 10a with respect to the entire gap core layer 6c. When a length of the first region 10a is denoted by a [μm] and a length of the second region 10b is denoted by b [μm], f=a/(a+b) is satisfied. Otherwise, a configuration of the second embodiment is similar to the configuration of the first embodiment.

In the first embodiment, the equivalent refractive index of the gap core layer 6c or, in other words, a height of the gap core layer 6c can only be uniquely determined according to a gap width and a refractive index of the material of the optical waveguides. However, in the present embodiment, the equivalent refractive index of the gap core layer 6c that is sensed by light propagating inside the optical waveguides is an average refractive index of the first and second regions 10a and 10b with different heights which are determined by the filling factor. Therefore, due to the introduction of the SWG structure, a combination of the two heights of the first and second regions 10a and 10b and the filling factor enables a directional coupler including an optimal branching ratio of optical power to be realized regardless of the gap width and the refractive index of the material of the optical waveguides.

FIG. 13 is a diagram showing a result of a calculation of a branching ratio of the directional coupler in the structure according to the second embodiment. The equivalent refractive index n_{gap1} in the height direction of the first region 10a was set to 3.055, the equivalent refractive index n_{gap2} of the second region 10b was set to 3.205, a period of the SWG structure was set to 0.22 micrometers, and the filling factor was set to 0.5. Other conditions are the same as shown in FIG. 3. A vicinity of x=−0.6 micrometers in the diagram is where the optical waveguide 2c is installed and a vicinity of x=0.4 micrometers in the diagram is where the optical waveguide 3c is installed.

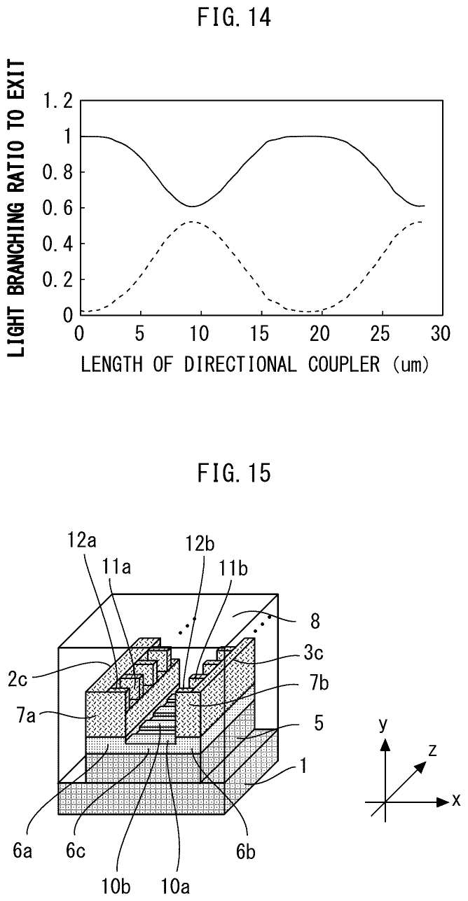

FIG. 14 is a diagram showing, by an overlap integral, a result of a calculation of a ratio of optical power included in each of the input-side first optical waveguide and the second optical waveguide with respect to an optical power distribution at each z position in FIG. 13. Due to a constraint of a calculation program, a structure with an equivalent refractive index smaller than a target value by around 10% was produced. Therefore, while a transition ratio of optical power is smaller compared to the calculation result of the first embodiment, generally, characteristics in the vicinity of an optical power transition ratio of 50% is obtained as targeted. This result shows that in order to keep the branching ratio of optical power to within 50%+10%, an admissible error of equation (2) from an optimal condition is approximately 10% which is similar to the first embodiment.

### Third Embodiment

FIG. 15 is a perspective view showing a directional coupler according to a third embodiment. In a similar manner to the second embodiment, the gap core layer 6c is an SWG structure in which first and second regions 10a and 10b are periodically repeated at a pitch equal to or shorter than a length of a net wavelength of light propagating through the optical waveguides 2c and 3c. The height of the second region 10b is lower than the height of the first region 10a.

In the present embodiment, engraved portions 11a and 11b with a width equal to or shorter than the width of the optical waveguides 2c and 3c and a depth that does not reach the core layers 6a and 6b are formed at a same period as the first and second regions 10a and 10b and at a same filling factor on mutually-opposing side surfaces of the upper cladding layers 7a and 7b of the optical waveguides 2c and 3c. Positions of the engraved portions 11a and 11b and the position of the second region 10b coincide with each other in a light propagation direction (z direction). Positions of non-engraved portions 12a and 12b of the side surfaces and the position of the first region 10a coincide with each other in the light propagation direction.

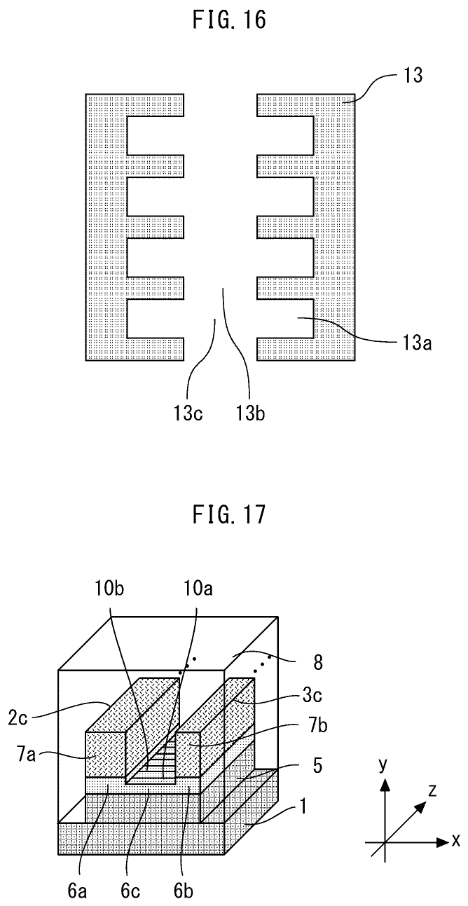

FIG. 16 is a plan view showing a mask used when forming a waveguide. An opening 13a of a mask 13 is a three-way wall with a small opening ratio. The engraved portions 11a and 11b are formed by etching in the opening 13a. An opening 13b is a two-way wall with a small opening ratio. The shallow first region 10a is formed by etching in the opening 13b. An opening 13c has no walls but has a large opening ratio. The deep second region 10b is formed by etching in the opening 13c. The optical waveguides 2c and 3c can be formed by one deep etching operation using a micro-loading effect in which an etching depth depends on the opening ratio of a mask. Since an actual opening shape of the mask depends heavily on an etching apparatus or conditions, a mask shape shown in FIG. 16 is merely an example.

When the engraved portions 11a and 11b are not formed on side surfaces of the upper cladding layers 7a and 7b of the optical waveguides 2c and 3c as in the second embodiment, an opening area ratio of the mask of regions where the first and second regions 10a and 10b are to be formed by etching becomes a constant value according to the filling factor. By comparison, in the present embodiment, the engraved portions 11a and 11b are allowed to be formed on mutually-opposing side surfaces of the upper cladding layers 7a and 7b of the optical waveguides 2c and 3c. Accordingly, since a mask opening corresponding to the second region 10b to be deeply etched can be widened in the width direction (x direction), an opening ratio during etching can be freely designed. By freely designing the opening ratio and the height of the gap core layer 6c, a structure which enables the engraved portions 11a and 11b to be collectively formed by a micro-loading effect can be realized. In addition, by preventing the depth of the engraved portions 11a and 11b formed on opposing side surfaces of the optical waveguides for opening ratio adjustment from reaching the core layers 6a and 6b, an effect on modes of light propagating inside the optical waveguides can be kept at a minimal level. Therefore, the condition represented by equation (2) of the second embodiment can be utilized without modification.

### Fourth Embodiment

FIG. 17 is a perspective view showing a directional coupler according to a fourth embodiment. The gap core layer 6c is a structure with a height that is engraved so as to be lower than the core layers 6a and 6b and in which first and second regions 10a and 10b with a same height but different refractive indexes are periodically repeated at a pitch equal to or shorter than a length of a net wavelength of light propagating through the optical waveguides 2c and 3c. The height of the gap core layer 6c, the refractive indexes of the first and second regions 10a and 10b, the filling factor, and the like are set so that the equivalent refractive index n_{gap1} of the first region 10a and the equivalent refractive index n_{gap2} of the second region 10b when the leakage of light in the height direction described earlier is taken into consideration satisfy equation (2) with an error of 10% or less. The first and second regions 10a and 10b can be formed by doping of an impurity or the like. For example, the structure according to the present embodiment can be applied utilizing alternative means with respect to a material of which fine etching is difficult such as LiNbO₃. Otherwise, a configuration and an effect of the fourth embodiment are similar to those of the first embodiment.

### Fifth Embodiment

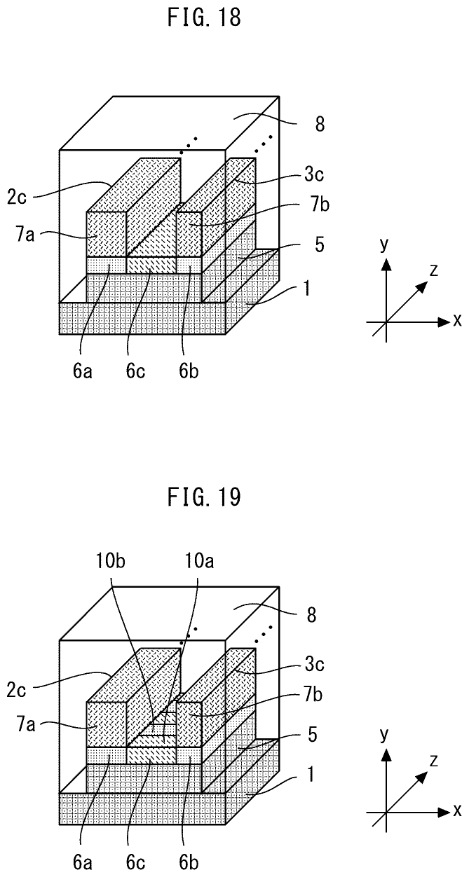

FIG. 18 is a perspective view showing a directional coupler according to a fifth embodiment. The gap core layer 6c has a same height as the core layers 6a and 6b and is made of a material with a lower refractive index than the core layers 6a and 6b. The refractive index of the gap core layer 6c is adjusted so that an equivalent refractive index n_{eff} of the gap core layer 6c when leakage of light in the height direction is taken into consideration satisfies equation (1) with an error of 10% or less. The low-refractive index gap core layer 6c can be formed by doping of an impurity or the like. For example, the structure according to the present embodiment can be applied utilizing alternative means with respect to a material of which fine etching is difficult such as LiNbO₃. In addition, the structure according to the present embodiment can also be formed by embedding other materials and options of manufacturing methods can be increased. Otherwise, a configuration and an effect of the fifth embodiment are similar to those of the first embodiment.

### Sixth Embodiment

FIG. 19 is a perspective view showing a directional coupler according to a sixth embodiment. The gap core layer 6c is an SWG structure in which first and second regions 10a and 10b with mutually different refractive indexes are periodically repeated at a pitch equal to or shorter than a length of a net wavelength of light propagating through the optical waveguides 2c and 3c. The first and second regions 10a and 10b have a same height as the core layers 6a and 6b and are made of a material with a lower refractive index than the core layers 6a and 6b. The refractive indexes of the first and second regions 10a and 10b, the filling factor, and the like are set so that the equivalent refractive index n_{gap1} of the first region 10a and the equivalent refractive index n_{gap2} of the second region 10b when the leakage of light in the height direction described earlier is taken into consideration satisfy equation (2) with an error of 10% or less. The first and second regions 10a and 10b of the gap core layer 6c can be formed by doping of an impurity or the like. For example, the structure according to the present embodiment can be applied utilizing alternative means with respect to a material of which fine etching is difficult such as LiNbO₃. In addition, the structure according to the present embodiment can also be formed by embedding other materials and options of manufacturing methods can be increased. Otherwise, a configuration and an effect of the sixth embodiment are similar to those of the first embodiment.

### REFERENCE SIGNS LIST

1 semiconductor substrate; 2 optical waveguide (first optical waveguide); 3 optical waveguide (second optical waveguide); 2b,3b optical waveguide (first curved waveguide); 2c,3c optical waveguide (optical power transition unit); 2d,3d optical waveguide (second curved waveguide); 5 lower cladding layer; 6a,6b core layer; 6c gap core layer; 7a,7b upper cladding layer; 8 peripheral cladding; 10a first region; 10b second region; 11a, 11b engraved portion; 12a, 12b non-engraved portion; 13 mask

1. A directional coupler comprising:
a semiconductor substrate;
first and second optical waveguides formed side by side on the semiconductor substrate and having a high-mesa structure; and
a peripheral cladding formed in a periphery of the first and second optical waveguides,
wherein the first and second optical waveguides include an optical power transition unit branching light propagating along one of the first and second optical waveguides at a desired power ratio to the first and second optical waveguides, first curved waveguides connected to an input side of the optical power transition unit and decreasing an interval between the first and second optical waveguides the closer to the optical power transition unit, and second curved waveguides connected to an output side of the optical power transition unit and increasing an interval between the first and second optical waveguides the farther from the optical power transition unit,
an interval between the first and second optical waveguides of the optical power transition unit is equal to or less than a wavelength of the light,
each of the first and second optical waveguides is a high-mesa structure which includes a lower cladding layer, a core layer, and an upper cladding layer which are sequentially stacked on the semiconductor substrate,
the first and second optical waveguides have different widths,
a gap core layer is formed on the lower cladding layer between the core layers of the first and second optical waveguides of the optical power transition unit, and
the gap core layer is made of a same material as the core layer and is engraved so that a height of the gap core layer is lower than the core layer,
the gap core layer is a structure in which first and second regions with different heights are periodically repeated at a pitch equal to or shorter than a length of a wavelength of the light,
n_{core} denotes a refractive index of the core layer and the gap core layer, n_{clad} denotes a refractive index of the peripheral cladding, k₀ denotes the number of waves of light propagating through a vacuum, w_{gap} denotes a proximity distance of the first and second optical waveguides of the optical power transition unit, f denotes a filling factor indicating a proportion of a length in a light propagation direction of the first region with respect to the entire gap core layer,
an equivalent refractive index ngap1 of the first region and an equivalent refractive index ngap2 of the second region when leakage of the light in the height direction is taken into consideration satisfy
$$( {n}_{core} - {n}_{clad} ) \times 0.09 \times ln ( {k}_{0} {w}_{gap} / 4.2 ) + 1. + {n}_{clad} = \frac{1}{f / {n}_{gap 1} + ( 1 - f ) / {n}_{gap 2}}$$
with an error of 10% or less.

2.-4. (canceled)

5. The directional coupler according to claim 1, wherein engraved portions with a width equal to or shorter than a width of the first and second optical waveguides and a depth that does not reach the core layer are formed at a same period and at a same filling factor as the first and second regions on mutually-opposing side surfaces of the upper cladding layers of the first and second optical waveguides,
a height of the second region is lower than a height of the first region,
a position of the engraved portion of the side surface and a position of the second region coincide with each other in a light propagation direction, and
a position of a non-engraved portion of the side surface and a position of the first region coincide with each other in the light propagation direction.

6. A directional coupler comprising:
a semiconductor substrate;
first and second optical waveguides formed side by side on the semiconductor substrate and having a high-mesa structure; and
a peripheral cladding formed in a periphery of the first and second optical waveguides,
wherein the first and second optical waveguides include an optical power transition unit branching light propagating along one of the first and second optical waveguides at a desired power ratio to the first and second optical waveguides, first curved waveguides connected to an input side of the optical power transition unit and decreasing an interval between the first and second optical waveguides the closer to the optical power transition unit, and second curved waveguides connected to an output side of the optical power transition unit and increasing an interval between the first and second optical waveguides the farther from the optical power transition unit,
an interval between the first and second optical waveguides of the optical power transition unit is equal to or less than a wavelength of the light,
each of the first and second optical waveguides is a high-mesa structure which includes a lower cladding layer, a core layer, and an upper cladding layer which are sequentially stacked on the semiconductor substrate,
the first and second optical waveguides have different widths,
a gap core layer is formed on the lower cladding layer between the core layers of the first and second optical waveguides of the optical power transition unit, and
the gap core layer is engraved so that a height of the gap core layer is lower than the core layer and is a structure in which first and second regions with a same height but different refractive indexes are periodically repeated at a pitch equal to or shorter than a length of a wavelength of the light,
n_{core} denotes a refractive index of the core layer and the gap core layer, n_{clad} denotes a refractive index of the peripheral cladding, k₀ denotes the number of waves of light propagating through a vacuum, w_{gap} denotes a proximity distance of the first and second optical waveguides of the optical power transition unit, f denotes a filling factor indicating a proportion of a length in a light propagation direction of the first region with respect to the entire gap core layer, an equivalent refractive index ngap1 of the first region and an equivalent refractive index ngap2 of the second region when leakage of the light in the height direction is taken into consideration satisfy
$$( {n}_{core} - {n}_{clad} ) \times 0.09 \times ln ( {k}_{0} {w}_{gap} / 4.2 ) + 1. + {n}_{clad} = \frac{1}{f / {n}_{gap 1} + ( 1 - f ) / {n}_{gap 2}}$$
with an error of 10% or less.

7. (canceled)

8. A directional coupler comprising:
a semiconductor substrate;
first and second optical waveguides formed side by side on the semiconductor substrate and having a high-mesa structure; and
a peripheral cladding formed in a periphery of the first and second optical waveguides,
wherein the first and second optical waveguides include an optical power transition unit branching light propagating along one of the first and second optical waveguides at a desired power ratio to the first and second optical waveguides, first curved waveguides connected to an input side of the optical power transition unit and decreasing an interval between the first and second optical waveguides the closer to the optical power transition unit, and second curved waveguides connected to an output side of the optical power transition unit and increasing an interval between the first and second optical waveguides the farther from the optical power transition unit,
an interval between the first and second optical waveguides of the optical power transition unit is equal to or less than a wavelength of the light,
each of the first and second optical waveguides is a high-mesa structure which includes a lower cladding layer, a core layer, and an upper cladding layer which are sequentially stacked on the semiconductor substrate,
the first and second optical waveguides have different widths,
a gap core layer is formed on the lower cladding layer between the core layers of the first and second optical waveguides of the optical power transition unit,
the gap core layer has a same height as the core layer and is made of a material with a lower refractive index than the core layer, and
the gap core layer is a structure in which first and second regions with different refractive indexes are periodically repeated at a pitch equal to or shorter than a length of a wavelength of the light,
n_{core} denotes a refractive index of the core layer and the gap core layer, n_{clad} denotes a refractive index of the peripheral cladding, k₀ denotes the number of waves of light propagating through a vacuum, w_{gap} denotes a proximity distance of the first and second optical waveguides of the optical power transition unit, f denotes a filling factor indicating a proportion of a length in a light propagation direction of the first region with respect to the entire gap core layer, an equivalent refractive index ngap1 of the first region and an equivalent refractive index ngap2 of the second region when leakage of the light in the height direction is taken into consideration satisfy
$$( {n}_{core} - {n}_{clad} ) \times 0.09 \times ln ( {k}_{0} {w}_{gap} / 4.2 ) + 1. + {n}_{clad} = \frac{1}{f / {n}_{gap 1} + ( 1 - f ) / {n}_{gap 2}}$$
with an error of 10% or less.

9. A method of manufacturing the directional coupler according to claim 5, wherein the first and second optical waveguides are formed by one deep etching operation using a micro-loading effect in which an etching depth depends on an opening ratio of a mask.
